(19) United States
(12) Patent Application Publication
(10) Pub. No.: US 2007/0083057 A1
(43) Pub. Date: Apr. 12, 2007

(54) Method for the production of nickel(0)-phosphorous ligand complexes

(75) Inventors: Gerd Haderlein, Grunstadt (DE); Robert Baumann, Mannheim (DE); Michael Bartsch, Neustadt (DE); Tim Jungkamp, Kapellen (DE); Hermann Luyken, Ludwigshafen (DE); Jens Scheidel, Hirschberg (DE); Wolfgang Siegel, Limburgerhof (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/576,679

(22) PCT Filed: Oct. 28, 2004
(86) PCT No.: PCT/EP04/12180

§ 371 Date: Apr. 21, 2006

(30) Foreign Application Priority Data
Oct. 30, 2003 (DE) 10351003.6

(51) Int. Cl. C07F 15/04

(52) U.S. Cl. 556/16

(57) ABSTRACT

The present invention provides a process for preparing nickel(0)-phosphorus ligand complexes starting from nickel(II)-ether adducts.

The present invention relates to a process for preparing nickel(0)-phosphorus ligand complexes. The present invention further provides the mixtures which comprise nickel(0)-phosphorus ligand complexes and are obtainable by this process, and also relates to their use in the hydrocyanation of alkenes or isomerization of unsaturated nitrites.

Nickel complexes of phosphorus ligands are suitable catalysts for hydrocyanations of alkenes. For example, nickel complexes having monodentate phosphites are known which catalyze the hydrocyanation of butadiene to prepare a mixture of isomeric pentenenitriles. These catalysts are also suitable in a subsequent isomerization of the branched 2-methyl-3-butenenitrile to linear 3-pentenenitrile and the hydrocyanation of the 3-pentenenitrile to adiponitrile, an important intermediate in the preparation of nylon-6,6.

U.S. Pat. No. 3,903,120 describes the preparation of zerovalent nickel complexes having monodentate phosphite ligands starting from nickel powder. The phosphorus ligands have the general formula PZ₃ where Z is an alkyl, alkoxy or aryloxy group. In this process, finely divided elemental nickel is used. In addition, preference is given to carrying out the reaction in the presence of a nitrilic solvent and in the presence of an excess of ligand.

U.S. Pat. No. 3,846,461 describes a process for preparing zerovalent nickel complexes with triorganophosphite ligands by reacting triorganophosphite compounds with nickel chloride in the presence of a finely divided reducing agent which is more electropositive than nickel. The reaction according to U.S. Pat. No. 3,846,461 takes place in the presence of a promoter which is selected from the group consisting of NH₃, NH₄X, Zn(NH₃)₂X₂ and mixtures of NH₄X and ZnX₂, where X is a halide.

New developments have shown that it is advantageous to use nickel complexes having chelate ligands (multidentate ligands) in the hydrocyanation of alkenes, since these allow both higher activities and higher selectivities to be achieved coupled with increased on-stream time. The above-described prior art processes are not suitable for preparing nickel complexes having chelate ligands. However, the prior art also discloses processes which enable the preparation of nickel complexes having chelate ligands.

U.S. Pat. No. 5,523,453 describes a process for preparing nickel-containing hydrocyanation catalysts which contain bidentate phosphorus ligands. These complexes are prepared starting from soluble nickel(0) complexes by transcomplexing with chelate ligands. The starting compounds used are Ni(COD)₂ or (oTTP)₂Ni(C₂H₄) (COD=1,5-cyclooctadiene; oTTP=P(O-ortho-C₆H₄CH₃)₃). As a consequence of the complicated preparation of the starting nickel compounds, this process is expensive.

Alternatively, there is the possibility of preparing nickel(0) complexes starting from bivalent nickel compounds and chelate ligands by reduction. In this method, it is generally necessary to work at high temperatures, so that thermally unstable ligands in the complex in some cases decompose.

US 2003/0100442 A1 describes a process for preparing a nickel(0) chelate complex, in which nickel chloride is reduced in the presence of a chelate ligand and of a nitrilic solvent using a more electropositive metal than nickel, in particular zinc or iron. In order to achieve a high space-time yield, an excess of nickel is used which has to be removed again after the complexation. The process is generally carried out with aqueous nickel chloride, which may lead to its decomposition especially when hydrolyzable ligands are used. When operation is effected with anhydrous nickel chloride, especially when hydrolyzable ligands are used, it is essential according to US 2003/0100442 A1 that the nickel chloride is initially dried by a specific process in which very small particles having large surface area and therefore high reactivity are obtained. A particular disadvantage of the process is that this fine nickel chloride dust prepared by spray drying is carcinogenic. A further disadvantage of this process is that operation is generally effected at elevated reaction temperatures, which may lead to decomposition of the ligands or of the complex especially in the case of thermally unstable ligands. It is a further disadvantage that operation has to be effected with an excess of reagents, in order to achieve economically viable conversions. These excesses have to be removed in a costly and inconvenient manner on completion of the reaction and optionally recycled.

GB 1 000 477 and BE 621 207 relate to processes for preparing nickel(0) complexes by reducing nickel(II) compounds using phosphorus ligands.

It is an object of the present invention to provide a process for preparing nickel(0) complexes having phosphorus ligands which substantially avoids the above-described disadvantages of the prior art. In particular, an anhydrous nickel source should be used, so that hydrolyzable ligands are not decomposed during the complexation. In addition, the reaction conditions should be gentle, so that thermally unstable ligands and the resulting complexes do not decompose. In addition, the process according to the invention should preferably enable the use of only a slight excess, if any, of the reagents, so that there is, if at all possible, no need to remove these substances after the complex has been prepared. The process should also be suitable for preparing nickel(0)-phosphorus ligand complexes having chelate ligands.

We have found that this object is achieved by a process for preparing a nickel(0)-phosphorus ligand complex which contains at least one nickel central atom and at least one phosphorus ligand.

In the process according to the invention, a nickel(II)-ether adduct is reduced in the presence of at least one phosphorus ligand.

The process according to the invention is preferably carried out in the presence of a solvent. The solvent is selected in particular from the group consisting of organic nitriles, aromatic hydrocarbons, aliphatic hydrocarbons and mixtures of the afore-mentioned solvents. With regard to the organic nitriles, preference is given to acetonitrile, propionitrile, n-butyronitrile, n-valeronitrile, cyanocyclopropane, acrylonitrile, crotonitrile, allyl cyanide, cis-2-pentenenitrile, trans-2-pentenenitrile, cis-3-pentenenitriie, trans-3-pentenenitrile, 4-pentenenitrile, 2-methyl-3-butenenitrile, Z-2-methyl-2-butenenitrile, E-2-methyl-2-butenenitrile, ethylsuccinonitrile, adiponitrile, methylglutaronitrile or mixtures thereof. With regard to the aromatic hydrocarbons, benzene, toluene, o-xylene, m-xylene, p-xylene or mixtures thereof may preferably be used. Aliphatic hydrocarbons may preferably be selected from the group of the linear or branched aliphatic hydrocarbons, more preferably from the group of the cycloaliphatics, such as cyclohexane or methylcyclohexane, or mixtures thereof. Particular preference is given to using cis-3-pentenenitrile, trans-3-pentenenitrile, adiponitrile, methylglutaronitrile or mixtures thereof as the solvent.

Preference is given to using an inert solvent.

The concentration of the solvent is preferably from 10 to 90% by mass, more preferably from 20 to 70% by mass, in particular from 30 to 60% by mass, based in each case on the finished reaction mixture.

The nickel(II)-ether adduct used in the process according to the invention is preferably anhydrous and, in a preferred embodiment, contains a nickel halide.

Useful nickel halides are nickel chloride, nickel bromide and nickel iodide. Preference is given to nickel chloride.

The nickel(II)-ether adduct used in the process according to the invention preferably includes an oxygen, sulfur or mixed oxygen-sulfur ether. This is preferably selected from the group consisting of tetrahydrofuran, dioxane, diethyl ether, di-n-propyl ether, diisopropyl ether, di-n-butyl ether, di-sec-butyl ether, ethylene glycol dialkyl ether, diethylene glycol dialkyl ether and triethylene gycol dialkyl ether. The ethylene glycol dialkyl ether used is preferably ethylene glycol dimethyl ether (1,2-dimethoxyethane, glyme) and ethylene glycol diethyl ether. The diethylene glycol dialkyl ether used is preferably diethylene glycol dimethyl ether (diglyme). The triethylene glycol dialkyl ether used is preferably triethylene glycol dimethyl ether (triglyme).

In a particular embodiment of the present invention, preference is given to using the nickel(II)chloride-ethylene glycol dimethyl ether adduct (NiCl₂.dme), the nickel(II) chloride-dioxane adduct (NiCl₂.dioxane) and the nickel(II) bromide-ethylene glycol dimethyl ether adduct (NiBr₂.dme). Particular preference is given to using NiCl₂.dme, which can be prepared, for example, according to Example 2 of DE 2 052 412. In this example, nickel chloride dihydrate is reacted in the presence of 1,2-dimethoxyethane with triethyl orthoformate as a dehydrating agent. Alternatively, the reaction may also be carried out with the aid of trimethyl orthoformate. NiCl₂.dioxane and NiBr₂.dme can be prepared in similar reactions, except that dioxane is used instead of 1,2-dimethoxyethane or nickel bromide hydrate is used instead of nickel chloride hydrate.

In a preferred embodiment of the present invention, the nickel(II)-ether adduct is prepared by admixing an aqueous solution of the nickel halide with the particular ether and a diluent, optionally with stirring, and then water and any excess ether are removed. The diluent is preferably selected from the above group of solvents which are suitable for complex formation. Water and any excess ether are preferably removed by distillation. A detailed description of the nickel(II)-ether adduct synthesis follows further down.

It is possible to use the nickel(II)-ether adduct directly in the solution or suspension obtained in this way to prepare the nickel(0)-phosphorus ligand complexes. Alternatively, the adduct may also initially be isolated and optionally dried, and be dissolved again or resuspended to prepare the nickel(0)-phosphorus ligand complex. The adduct can be isolated from the suspension by processes known per se to those skilled in the art such as filtration, centrifugation, sedimentation or by hydrocyclones, as described, for example, in Ullmann's Encyclopedia of Industrial Chemistry, Unit Operation I, Vol. B2, VCH, Weinheim, 1988, in chapter 10, pages 10-1 to 10-59, chapter 11, pages 11-1 to 11-27 and chapter 12, pages 12-1 to 12-61.

Ligands

In the process according to the invention, phosphorus ligands are used which are preferably selected from the group consisting of mono- or bidentate phosphines, phosphites, phosphinites and phosphonites.

These phosphorus ligands preferably have the formula I
P(X¹R¹)(X²R²)(X³R³) (I)

In the context of the present invention, compound I is a single compound or a mixture of different compounds of the aforementioned formula.

According to the invention, X¹, X², X³ each independently are oxygen or a single bond. When all of the X¹, X² and X³ groups are single bonds, compound I is a phosphine of the formula P(R¹ R² R³) with the definitions of R¹, R² and R³ specified in this description.

When two of the X¹, X² and X³ groups are single bonds and one is oxygen, compound I is a phosphinite of the formula P(OR¹)(R²)(R³) or P(R¹)(OR²)(R³) or P(R¹)(R²)(OR³) with the definitions of R¹, R² and R³ specified below.

When one of the X¹, X² and X³ groups is a single bond and two are oxygen, compound I is a phosphonite of the formula P(OR¹)(OR²)(R³) or P(R¹)(OR²)(OR³) or P(OR¹)(R²)(OR³) with the definitions of R¹, R² and R³ specified in this description.

In a preferred embodiment, all X¹, X² and X³ groups should be oxygen, so that compound I is advantageously a phosphite of the formula P(OR¹)(OR²)(OR³) with the definitions of R¹, R² and R³ specified below.

According to the invention, R¹, R², R³ are each independently identical or different organic radicals. R¹, R² and R³ are each independently alkyl radicals preferably having from 1 to 10 carbon atoms, such as methyl, ethyl, n-propyl, i-propyl, n-butyl, i-butyl, s-butyl, t-butyl, aryl groups such as phenyl, o-tolyl, m-tolyl, p-tolyl, 1-naphthyl, 2-naphthyl, or hydrocarbyl, preferably having from 1 to 20 carbon atoms, such as 1,1′-biphenol, 1,1′-binaphthol. The R¹, R² and R³ groups may be bonded together directly, i.e. not solely via the central phosphorus atom. Preference is given to the R¹, R² and R³ groups not being bonded together directly.

In a preferred embodiment, R¹, R² and R³ are radicals selected from the group consisting of phenyl, o-tolyl, m-tolyl and p-tolyl. In a particularly preferred embodiment, a maximum of two of the R¹, R² and R³ groups should be phenyl groups.

In another preferred embodiment, a maximum of two of the R¹, R² and R³ groups should be o-tolyl groups.

Particularly preferred compounds I which may be used are those of the formula Ia
(o-tolyl-O-)_{w}(m-tolyl-O-)ₓ(p-tolyl-O-)_{y}(phenyl-O—)_{z}P (Ia)
where w, x, y, z are each a natural number, and the following conditions apply: w+x+y+z=3 and w, z<2.

Such compounds Ia are, for example (p-tolyl-O-)(phenyl-O—)₂P, (m-tolyl-O-)(phenyl-O—)₂P, (o-tolyl-O-)(phenyl-O—)₂P, (p-tolyl-O-)₂(phenyl-O—)P, (m-tolyl-O-)₂(phenyl-O—)P, (o-tolyl-O-)₂(phenyl-O—)P, (m-tolyl-O-)(p-tolyl-O-)(phenyl-O—)P, (o-tolyl-O-)(p-tolyl-O-)(phenyl-O—)P, (o-tolyl-O-)(m-tolyl-O-)(phenyl-O—)P, (p-tolyl-O—)₃P, (m-tolyl-O-)(p-tolyl-O—)₂P, (o-tolyl-O-)(p-tolyl-O—)₂P, (m-tolyl-O-)₂(p-tolyl-O—)P, (o-tolyl-O-)₂(p-tolyl-O—)P, (o-tolyl-O-)(m-tolyl-O-)(p-tolyl-O—)P, (m-tolyl-O—)₃P, (o-tolyl-O-)(m-tolyl-O—)₂P (o-tolyl-O-)₂(m-tolyl-O—)P or mixtures of such compounds.

Mixtures comprising (m-tolyl-O—)₃P, (m-tolyl-O-)₂(p-tolyl-O—)P, (m-tolyl-O-)(p-tolyl-O—)₂P and (p-tolyl-O—)₃P may be obtained for example by reacting a mixture comprising m-cresol and p-cresol, in particular in a molar ratio of 2:1, as obtained in the distillative workup of crude oil, with a phosphorus trihalide, such as phosphorus trichloride.

In another, likewise preferred embodiment, the phosphorus ligands are the phosphites, described in detail in DE-A 199 53 058, of the formula Ib:
P(O—R¹)ₓ(O—R²)_{y}(O—R³)_{z}(O—R⁴)ₚ (Ib)
where
R¹: aromatic radical having a C₁-C₁₈-alkyl substituent in the o-position to the oxygen atom which joins the phosphorus atom to the aromatic system, or having an aromatic substituent in the o-position to the oxygen atom which joins the phosphorus atom to the aromatic system, or having a fused aromatic system in the o-position to the oxygen atom which joins the phosphorus atom to the aromatic system,
R²: aromatic radical having a C₁-C₁₈-alkyl substituent in the m-position to the oxygen atom which joins the phosphorus atom to the aromatic system, or having an aromatic substituent in the m-position to the oxygen atom which joins the phosphorus atom to the aromatic system, or having a fused aromatic system in the m-position to the oxygen atom which joins the phosphorus atom to the aromatic system, the aromatic radical bearing a hydrogen atom in the o-position to the oxygen atom which joins the phosphorus atom to the aromatic system,
R³: aromatic radical having a C₁-C₁₈-alkyl substituent in the p-position to the oxygen atom which joins the phosphorus atom to the aromatic system, or having an aromatic substituent in the p-position to the oxygen atom which joins the phosphorus atom to the aromatic system, the aromatic radical bearing a hydrogen atom in the o-position to the oxygen atom which joins the phosphorus atom to the aromatic system,
R⁴: aromatic radical which bears substituents other than those defined for R¹, R² and R³ in the o-, m- and p-position to the oxygen atom which joins the phosphorus atom to the aromatic system, the aromatic radical bearing a hydrogen atom in the o-position to the oxygen atom which joins the phosphorus atom to the aromatic system,
x: 1 or 2,
y, z, p: each independently 0, 1 or 2, with the proviso that x+y+z+p=3.

Preferred phosphites of the formula Ib can be taken from DE-A 199 53 058. The R¹ radical may advantageously be o-tolyl, o-ethylphenyl, o-n-propylphenyl, o-isopropyl-phenyl, o-n-butylphenyl, o-sec-butylphenyl, o-tert-butylphenyl, (o-phenyl)phenyl or 1-naphthyl groups.

Preferred R² radicals are m-tolyl, m-ethylphenyl, m-n-propylphenyl, m-isopropylphenyl, m-n-butylphenyl, m-sec-butylphenyl, m-tert-butylphenyl, (m-phenyl)phenyl or 2-naphthyl groups.

Advantageous R³ radicals are p-tolyl, p-ethylphenyl, p-n-propylphenyl, p-isopropyl-phenyl, p-n-butylphenyl, p-sec-butylphenyl, p-tert-butylphenyl or (p-phenyl)phenyl groups.

The R⁴ radical is preferably phenyl. p is preferably zero. For the indices x, y and z and p in compound Ib, there are the following possibilities:

| x | y | z | p |
|---|---|---|---|
| 1 | 0 | 0 | 2 |
| 1 | 0 | 1 | 1 |
| 1 | 1 | 0 | 1 |
| 2 | 0 | 0 | 1 |
| 1 | 0 | 2 | 0 |
| 1 | 1 | 1 | 0 |
| 1 | 2 | 0 | 0 |
| 2 | 0 | 1 | 0 |
| 2 | 1 | 0 | 0 |

Preferred phosphites of the formula Ib are those in which p is zero, and R¹, R² and R³ are each independently selected from o-isopropylphenyl, m-tolyl and p-tolyl, and R⁴ is phenyl.

Particularly preferred phosphites of the formula Ib are those in which R¹ is the o-isopropylphenyl radical, R² is the m-tolyl radical and R³ is the p-tolyl radical with the indices specified in the table above; also those in which R¹ is the o-tolyl radical, R² is the m-tolyl radical and R³ is the p-tolyl radical with the indices specified in the table; additionally those in which R¹ is the 1-naphthyl radical, R² is the m-tolyl radical and R³ is the p-tolyl radical with the indices specified in the table; also those in which R¹ is the o-tolyl radical, R² is the 2-naphthyl radical and R³ is the p-tolyl radical with the indices specified in the table; and finally those in which R¹ is the o-isopropylphenyl radical, R² is the 2-naphthyl radical and R³ is the p-tolyl radical with the indices specified in the table; and also mixtures of these phosphites.

Phosphites of the formula Ib may be obtained by
a) reacting a phosphorus trihalide with an alcohol selected from the group consisting of R¹OH, R²OH, R³OH and R⁴OH or mixtures thereof to obtain a dihalophosphorous monoester,
b) reacting the dihalophosphorous monoester mentioned with an alcohol selected from the group consisting of R¹OH, R²OH, R³OH and R⁴OH or mixtures thereof to obtain a monohalophosphorous diester and
c) reacting the monohalophosphorous diester mentioned with an alcohol selected from the group consisting of R¹OH, R²OH, R³OH and R⁴OH or mixtures thereof to obtain a phosphite of the formula Ib.

The reaction may be carried out in three separate steps. Equally, two of the three steps may be combined, i.e. a) with b) or b) with c). Alternatively, all of steps a), b) and c) may be combined together.

Suitable parameters and amounts of the alcohols selected from the group consisting of R¹OH, R²OH, R³OH and R⁴OH or mixtures thereof may be determined readily by a few simple preliminary experiments.

Useful phosphorus trihalides are in principle all phosphorus trihalides, preferably those in which the halide used is Cl, Br, I, in particular Cl, and mixtures thereof. It is also possible to use mixtures of identically or differently halogen-substituted phosphines as the phosphorus trihalide. Particular preference is given to PCl₃. Further details on the reaction conditions in the preparation of the phosphites Ib and for the workup can be taken from DE-A 199 53 058.

The phosphites Ib may also be used in the form of a mixture of different phosphites Ib as a ligand. Such a mixture may be obtained, for example, in the preparation of the phosphites Ib.

However, preference is given to the phosphorus ligand being multidentate, in particular bidentate. The ligand used therefore preferably has the formula II 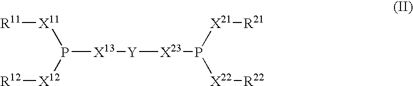
where
X¹, X¹², X¹³ X²¹, X²², X²³ are each independently oxygen or a single bond
R¹¹, R¹² are each independently identical or different, separate or bridged organic radicals
R²¹, R²² are each independently identical or different, separate or bridged organic radicals,
Y is a bridging group.

In the context of the present invention, compound II is a single compound or a mixture of different compounds of the aforementioned formula.

In a preferred embodiment, X¹¹, X¹², X¹³, X²¹, X²², X²³ may each be oxygen. In such a case, the bridging group Y is bonded to phosphite groups.

In another preferred embodiment, X¹¹ and X¹² may each be oxygen and X¹³ a single bond, or X¹¹ and X¹³ each oxygen and X¹² a single bond, so that the phosphorus atom surrounded by X¹¹, X¹² and X¹³ is the central atom of a phosphonite. In such a case, X²¹, X²² and X²³ may each be oxygen, or X²¹ and X²² may each be oxygen and X²³ a single bond, or X²¹ and X²³ may each be oxygen and X²² a single bond, or X²³ may be oxygen and X²¹ and X²² each a single bond, or X²¹ may be oxygen and X²² and X²³ each a single bond, or X²¹, X²² and X²³ may each be a single bond, so that the phosphorus atom surrounded by X²¹, X²² and X²³ may be the central atom of a phosphite, phosphonite, phosphinite or phosphine, preferably a phosphonite.

In another preferred embodiment, X¹³ may be oxygen and X¹¹ and X¹² each a single bond, or X¹¹ may be oxygen and X¹² and X¹³ each a single bond, so that the phosphorus atom surrounded by X¹¹, X¹² and X¹³ is the central atom of a phosphonite. In such a case, X²¹, X²² and X²³ may each be oxygen, or X²³ may be oxygen and X²¹ and X²² each a single bond, or X²¹ may be oxygen and X²² and X²³ each a single bond, or X²¹, X²² and X²³ may each be a single bond, so that the phosphorus atom surrounded by X²¹, X²² and X²³ may be the central atom of a phosphite, phosphinite or phosphine, preferably a phosphinite.

In another preferred embodiment, X¹¹, X¹² and X¹³ may each be a single bond, so that the phosphorus atom surrounded by X¹¹, X¹² and X¹³ is the central atom of a phosphine. In such a case, X²¹, X²² and X²³ may each be oxygen, or X²¹, X²² and X²³ may each be a single bond, so that the phosphorus atom surrounded by X²¹, X²² and X²³ may be the central atom of a phosphite or phosphine, preferably a phosphine.

The bridging group Y is advantageously an aryl group which is substituted, for example by C₁-C₄-alkyl, halogen, such as fluorine, chlorine, bromine, halogenated alkyl, such as trifluoromethyl, aryl, such as phenyl, or is unsubstituted, preferably a group having from 6 to 20 carbon atoms in the aromatic system, in particular pyrocatechol, bis(phenol) or bis(naphthol).

The R¹¹ and R¹² radicals may each independently be identical or different organic radicals. Advantageous R¹¹ and R¹² radicals are aryl radicals, preferably those having from 6 to 10 carbon atoms, which may be unsubstituted or mono- or polysubstituted, in particular by C₁-C₄-alkyl, halogen, such as fluorine, chlorine, bromine, halogenated alkyl, such as trifluoromethyl, aryl, such as phenyl, or unsubstituted aryl groups.

The R²¹ and R²² radicals may each independently be the same or different organic radicals. Advantageous R²¹ and R²² radicals are aryl radicals, preferably those having from 6 to 10 carbon atoms, which may be unsubstituted or mono- or polysubstituted, in particular by C₁-C₄-alkyl, halogen, such as fluorine, chlorine, bromine, halogenated alkyl, such as trifluoromethyl, aryl, such as phenyl, or unsubstituted aryl groups.

The R¹¹ and R¹² radicals may each be separate or bridged. The R²¹ and R²² radicals may also each be separate or bridged. The R¹¹, R¹², R²¹ and R²² radicals may each be separate, two may be bridged and two separate, or all four may be bridged, in the manner described.

In a particularly preferred embodiment, useful compounds are those of the formula I, II, III, IV and V specified in U.S. Pat. No. 5,723,641. In a particularly preferred embodiment, useful compounds are those of the formula I, II, III, IV, V, VI and VII specified in U.S. Pat. No. 5,512,696, in particular the compounds used there in examples 1 to 31. In a particularly preferred embodiment, useful compounds are those of the formula I, I, III, IV, V, VI, VII, VIII, IX, X, XI, XII, XIII, XIV and XV specified in U.S. Pat. No. 5,821,378, in particular the compounds used there in examples 1 to 73.

In a particularly preferred embodiment, useful compounds are those of the formula I, II, III, IV, V and VI specified in U.S. Pat. No. 5,512,695, in particular the compounds used there in examples 1 to 6. In a particularly preferred embodiment, useful compounds are those of the formula I, II, III, IV, V, VI, VII, VIII, IX, X, XI, XII, XIII and XIV specified in U.S. Pat. No. 5,981,772, in particular the compounds used there in examples 1 to 66.

In a particularly preferred embodiment, useful compounds are those specified in U.S. Pat. No. 6,127,567 and the compounds used there in examples 1 to 29. In a particularly preferred embodiment, useful compounds are those of the formula I, II, III, IV, V, VI, VII, VIII, IX and X specified in U.S. Pat. No. 6,020,516, in particular the compounds used there in examples 1 to 33. In a particularly preferred embodiment, useful compounds are those specified in U.S. Pat. No. 5,959,135, and the compounds used there in examples 1 to 13.

In a particularly preferred embodiment, useful compounds are those of the formula I, II and III specified in U.S. Pat. No. 5,847,191. In a particularly preferred embodiment, useful compounds are those specified in U.S. Pat. No. 5,523,453, in particular the compounds illustrated there in formula 1, 2, 3, 4, 5, 6, 7, 8, 9, 10, 11, 12, 13, 14, 15, 16, 17, 18, 19, 20 and 21. In a particularly preferred embodiment, useful compounds are those specified in WO 01/14392, preferably the compounds illustrated there in formula V, VI, VII, VIII, IX, X, XI, XII, XIII, XIV, XV, XVI, XVII, XXI, XXII, XXIII.

In a particularly preferred embodiment, useful compounds are those specified in WO 98/27054. In a particularly preferred embodiment, useful compounds are those specified in WO 99/13983. In a particularly preferred embodiment, useful compounds are those specified in WO 99/64155.

In a particularly preferred embodiment, useful compounds are those specified in the German patent application DE 100 380 37. In a particularly preferred embodiment, useful compounds are those specified in the German patent application DE 100 460 25. In a particularly preferred embodiment, useful compounds are those specified in the German patent application DE 101 502 85.

In a particularly preferred embodiment, useful compounds are those specified in the German patent application DE 101 502 86. In a particularly preferred embodiment, useful compounds are those specified in the German patent application DE 102 071 65. In a further particularly preferred embodiment of the present invention, useful phosphorus chelate ligands are those specified in US 2003/0100442 A1.

In a further particularly preferred embodiment of the present invention, useful phosphorus chelate ligands are those specified in the German patent application DE 103 50 999.2 of Oct. 30, 2003 which has an earlier priority date but had not been published at the priority date of the present application.

The compounds I, Ia, Ib and II described and their preparation are known per se. The phosphorus ligands used may also be mixtures comprising at least two of the compounds I, Ia, Ib and II.

In a particularly preferred embodiment of the process according to the invention, the phosphorus ligand of the nickel(0) complex and/or the free phosphorus ligand is selected from tritolyl phosphite, bidentate phosphorus chelate ligands and the phosphites of the formula Ib
P(O—R¹)ₓ(O—R²)_{y}(O—R³)_{z}(O—R⁴)ₚ (I b)
where R¹, R² and R³ are each independently selected from o-isopropylphenyl, m-tolyl and p-tolyl, R⁴ is phenyl; x is 1 or 2, and y, z, p are each independently 0, 1 or 2 with the proviso that x+y+z+p=3; and mixtures thereof.

In the process according to the invention, the concentration of the ligand in the solvent is preferably from 1 to 90% by weight, more preferably from 5 to 80% by weight, in particular from 50 to 80% by weight.

In the process according to the invention, the ligand to be used may also be present in a ligand solution which has already been used as a catalyst solution in hydrocyanation reactions and which is depleted of nickel(0). This residual catalyst solution generally has the following composition:
from 2 to 60% by weight, in particular from 10 to 40% by weight, of pentenenitriles,
from 0 to 60% by weight, in particular from 0 to 40% by weight, of adiponitrile,
from 0 to 10% by weight, in particular from 0 to 5% by weight, of other nitriles,
from 10 to 90% by weight, in particular from 50 to 90% by weight, of phosphorus ligand and
from 0 to 2% by weight, in particular from 0 to 1% by weight, of nickel(0).

In the process according to the invention, the free ligand present in the residual catalyst solution may thus be converted back to a nickel(0) complex.

The reducing agent used in the process according to the invention is preferably selected from the group consisting of metals which are more electropositive than nickel, metal alkyls, electrical current, complex hydrides and hydrogen.

When the reducing agent in the process according to the invention is a metal which is more electropositive than nickel, this metal is preferably selected from the group consisting of sodium, lithium, potassium, magnesium, calcium, barium, strontium, titanium, vanadium, iron, cobalt, copper, zinc, cadmium, aluminum, gallium, indium, tin, lead and thorium. Particular preference is given in this context to iron and zinc. When aluminum is used as the reducing agent, it is advantageous when it is preactivated by reaction with a catalytic amount of mercury(II) salt or metal alkyl. Preference is given to using triethylaluminum for the preactivation in an amount of preferably from 0.05 to 50 mol %, more preferably from 0.5 to 10 mol %. The reduction metal is preferably finely divided, the expression “finely divided” meaning that the metal is used in a particle size of less than 10 mesh, more preferably less than 20 mesh.

When the reducing agent used in the process according to the invention is a metal which is more electropositive than nickel, the amount of metal is preferably from 0.1 to 50% by weight, based on the reaction mixture.

When metal alkyls are used as reducing agents in the process according to the invention, they are preferably lithium alkyls, sodium alkyls, magnesium alkyls, in particular Grignard reagents, zinc alkyls or aluminum alkyls. Particular preference is given to aluminum alkyls such as trimethylaluminum, triethylaluminum, triisopropylaluminum or mixtures thereof, in particular triethylaluminum. The metal alkyls may be used without solvent or dissolved in an inert organic solvent such as hexane, heptane or toluene.

When complex hydrides are used as the reducing agent in the process according to the invention, preference is given to using metal aluminum hydrides such as lithium aluminum hydride, or metal borohydrides such as sodium borohydride.

The molar ratio of redox equivalents between the nickel(II) source and the reducing agent is preferably from 1:1 to 1:100, more preferably from 1:1 to 1:50, in particular from 1:1 to 1:5.

In the process according to the invention, the duration of the process according to the invention is preferably from 30 minutes to 24 hours, more preferably from 30 minutes to 10 hours, in particular from 1 to 3 hours.

The molar ratio between nickel(II)-ether adduct and ligand is preferably from 1:1 to 1:100, more preferably from 1:1 to 1:3, in particular from 1:1 to 1:2. The reduction preferably takes place at a temperature of from 30 to 90° C., more preferably from 35 to 80° C., in particular from 40 to 70° C. However, it is also possible in accordance with the invention to work at higher temperatures, although a reaction at low temperature is recommended especially when thermally unstable ligands are used.

The process according to the invention may be carried out at any pressure. For practical reasons, preference is given to pressures between 0.1 bar abs and 5 bar abs, preferably 0.5 bar abs and 1.5 bar abs.

The process according to the invention is preferably carried out under inert gas, for example argon or nitrogen.

The process according to the invention may be carried out in batch mode or continuously.

In a particularly preferred embodiment, the process according to the invention comprises the following process steps:
(1) preparing a solution or suspension of the at least one nickel(II)-ether adduct and of the at least one ligand in a solvent under inert gas,
(2) stirring the solution or suspension stemming from process step (1) at a temperature of from 20 to 120° C. for a period of from 1 minute to 24 hours for precomplexation,
(3) adding the reducing agent at a temperature of from 20 to 120° C. to the solution or suspension stemming from process step (2),
(4) stirring the solution or suspension stemming from process step (3) at a temperature of from 20 to 120° C.

The precomplexation temperatures, addition temperatures, and reaction temperatures may each independently be from 20° C. to 120° C. In the precomplexation, addition and reaction, particular preference is given to temperatures of from 30° C. to 80° C.

The precomplexation periods, addition periods and reaction periods may each independently be from 1 minute to 24 hours. The precomplexation period is in particular from 1 minute to 3 hours. The addition period is preferably from 1 minute to 30 minutes. The reaction period is preferably from 20 minutes to 5 hours.

The process according to the invention has the advantage of a high reactivity of the nickel(II)-ether adduct. This makes reaction possible even at low temperatures. Moreover, it is not necessary to use an excess of nickel salt, as disclosed by the prior art. In addition, complete conversion with respect to the nickel(II)-ether adduct and the reducing agent may be achieved, which makes its subsequent removal superfluous. As a consequence of the high reactivity, nickel: ligand ratios of up to 1:1 may be obtained.

The present invention further provides the solutions comprising nickel(0)-phosphorus ligand complexes obtainable by the process according to the invention, and also their use in the hydrocyanation of alkenes and of unsaturated nitriles, in particular in the hydrocyanation of butadiene to prepare a mixture of pentenenitriles and the hydrocyanation of pentenenitriles to adiponitrile. The present invention also relates to their use in the isomerization of alkenes and of unsaturated nitriles, in particular of 2-methyl-3-butenenitrile to 3-pentenenitrile.

The present invention further provides a process for preparing a nickel(II)-ether adduct. In a preferred embodiment of the present invention, this nickel(II)-ether adduct may be used as a reactant in the above-described process for preparing nickel(0)-phosphorus ligand complexes. In this process for preparing a nickel(II)-ether adduct, an aqueous nickel(II) halide is admixed with an ether and a diluent, optionally with stirring, and then water, the diluent and any excess ether are removed.

The aqueous nickel(II) halide and the ether are preferably stirred over a period of from 3 minutes to 24 hours, more preferably from 5 minutes to 3 hours. The nickel(II) halide and the ether may be stirred in the presence of a diluent. Alternatively, it is also possible only to add the diluent after the stirring.

When the nickel(II)-ether adduct is prepared, the water and any excess ether are preferably removed by an azeotropic distillation with a diluent. The azeotropic distillation is preferably carried out in such a way that water is removed from a mixture comprising aqueous nickel(II) halide, the ether and the diluent, and a diluent is used whose boiling point, in the case that the diluent does not form an azeotrope with water under the pressure conditions of the distillation mentioned below, is higher than the boiling point of water and is liquid at this boiling point of water, or which forms an azeotrope or heteroazeotrope with water under the pressure and temperature conditions of the distillation mentioned below, and the mixture comprising the aqueous nickel(II) halide, the ether and the diluent is distilled to remove water, any excess ether or the azeotrope mentioned or the heteroazeotrope mentioned from this mixture to obtain an anhydrous mixture comprising the nickel(II)-ether adduct and said diluent.

With regard to the nickel halides and ethers to be used, reference is made to the above remarks on the process according to the invention for preparing nickel(0)-phosphorus ligand complexes.

Aqueous nickel(II) halide is a nickel halide which is selected from the group of nickel chloride, nickel bromide and nickel iodide and which contains at least 2% by weight of water. Examples thereof are nickel chloride dihydrate, nickel chloride hexahydrate, an aqueous solution of nickel chloride, nickel bromide trihydrate, an aqueous solution of nickel bromide, nickel iodide hydrate or an aqueous solution of nickel iodide. In the case of nickel chloride, preference is given to using nickel chloride hexahydrate or an aqueous solution of nickel chloride. In the case of nickel bromide and nickel iodide, preference is given to using the aqueous solutions. Particular preference is given to an aqueous solution of nickel chloride.

In the case of an aqueous solution, the concentration of nickel(II) halide in water is not critical per se. It has been found that an advantageous proportion of the nickel(II) halide in the total weight of nickel(II) halide and water is at least 0.01% by weight, preferably at least 0.1% by weight, more preferably at least 0.25% by weight, especially preferably at least 0.5% by weight. An advantageous proportion of the nickel(II) halide in the total weight of nickel(II) halide and water is in the range of at most 80% by weight, preferably at most 60% by weight, more preferably at most 40% by weight. For practical reasons, it is advantageous not to exceed a proportion of nickel halide in the mixture of nickel halide and water which results in a solution under the given temperature and pressure conditions. In the case of an aqueous solution of nickel chloride, it is therefore advantageous for practical reasons to select at room temperature a proportion of nickel halide in the total weight of nickel chloride and water or at most 31% by weight. At higher temperatures, appropriately high concentrations may be selected which result from the solubility of nickel chloride in water.

The ether used is preferably an oxygen, sulfur or mixed oxygen-sulfur ether. It is preferably selected from the group consisting of tetrahydrofuran, dioxane, diethyl ether, di-n-propyl ether, diisopropyl ether, di-n-butyl ether, di-sec-butyl ether, ethylene glycol dialkyl ether, diethylene glycol dialkyl ether and triethylene glycol dialkyl ether. The ethylene glycol dialkyl ether used is preferably ethylene glycol dimethyl ether (1,2-dimethoxyethane, glyme) and ethylene glycol diethyl ether. The diethylene glycol dialkyl ether used is preferably diethylene glycol dimethyl ether (diglyme). The triethylene glycol dialkyl ether used is preferably triethylene glycol dimethyl ether (triglyme).

The ratio of nickel halide to ether used is preferably from 1:1 to 1:1.5, more preferably from 1:1 to 1:1.3.

The starting mixture for the azeotropic distillation may consist of aqueous nickel(II) halide and ether. In addition to aqueous nickel(II) halide and ether, the starting mixture may contain further constituents such as ionic or nonionic, organic or inorganic compounds, in particular those which are homogeneously and monophasically miscible with the starting mixture or soluble in the starting mixture.

The pressure conditions for the subsequent distillation are not critical per se. Advantageous pressures have been found to be at least 10⁻⁴ MPa, preferably at least 10⁻³ MPa, in particular at least 5·10⁻³ MPa. Advantageous pressures have been found to be at most 1 MPa, preferably at most 5·10⁻¹ MPa, in particular at most 1.5·10⁻¹ MPa.

Depending on the pressure conditions and the composition of the mixture to be distilled, a distillation temperature is then established. At this temperature, the diluent is preferably in liquid form. In the context of the present invention, the term diluent refers either to an individual diluent or to a mixture of diluents, in which case the physical properties mentioned in the case of such a mixture in the present invention relate to this mixture.

In addition, the diluent preferably has a boiling point under these pressure and temperature conditions which, in the case that the diluent does not form an azeotrope with water, is higher than that of water, preferably by at least 5° C., in particular at least 20° C., and preferably at most 200° C., in particular at most 100° C.

In a preferred embodiment, diluents may be used which form an azeotrope or heteroazeotrope with water. The amount of diluent compared to the amount of water in the mixture is not critical per se. Advantageously, more liquid diluent should be used than corresponds to the amount to be distilled off by the azeotropes, so that excess diluent remains as the bottom product.

When a diluent is used which does not form an azeotrope with water, the amount of diluent compared to the amount of water in the mixture is not critical per se.

The diluent used is selected in particular from the group consisting of organic nitriles, aromatic hydrocarbons, aliphatic hydrocarbons and mixtures of the aforementioned solvents. With regard to the organic nitriles, preference is given to acetonitrile, propionitrile, n-butyronitrile, n-valeronitrile, cyanocyclopropane, acrylonitrile, crotonitrile, allyl cyanide, cis-2-pentenenitrile, trans-2-pentenenitrile, cis-3-pentenenitrile, trans-3-pentenenitrile, 4-pentenenitrile, 2-methyl-3-butenenitrile, Z-2-methyl-2-butenenitrile, E-2-methyl-2-butenenitrile, ethylsuccinonitrile, adiponitrile, methylglutaronitrile or mixtures thereof. With regard to the aromatic hydrocarbons, benzene, toluene, o-xylene, m-xylene, p-xylene or mixtures thereof may preferably be used. Aliphatic hydrocarbons may preferably be selected from the group of the linear or branched aliphatic hydrocarbons, more preferably from the group of the cycloaliphatics, such as cyclohexane or methylcyclohexane, or mixtures thereof. Particular preference is given to using cis-3-pentenenitrile, trans-3-pentenenitrile, adiponitrile, methylglutaronitrile or mixtures thereof as the solvent.

When the diluent used is an organic nitrile or mixtures comprising at least one organic nitrile, it has been found to be advantageous to select the amount of diluent in such a way that the proportion of nickel(II) halide in the total weight of nickel(II) halide and diluent in the finished mixture is at least 0.05% by weight, preferably at least 0.5% by weight, more preferably at least 1% by weight.

When the diluent used is an organic nitrile or mixtures comprising at least one organic nitrile, it has been found to be advantageous to select the amount of diluent in such a way that the proportion of nickel(II) halide in the total weight of nickel(II) halide and diluent in the finished mixture is at most 50% by weight, preferably at most 30% by weight, more preferably at most 20% by weight.

According to the invention, the mixture comprising the aqueous nickel(II) halide, the ether and the diluent is distilled to remove water and any excess ether from this mixture to obtain an anhydrous mixture comprising nickel(II)-ether adduct and said diluent. In a preferred embodiment, the mixture is initially prepared and subsequently distilled. In another preferred embodiment, the aqueous nickel halide, more preferably the aqueous solution of the nickel halide, is added gradually to the boiling diluent during the distillation. This allows the formation of a greasy solid which is difficult to handle from a process technology point of view to be substantially prevented.

In a particular embodiment of the present invention, the diluent is identical to the solvent which is used in the above-described process according to the invention for preparing the nickel(0)-phosphorus ligand complex.

The distillation temperature of the azeotropic distillation depends substantially upon the ether used and upon the diluent used. In a system in which 1,2-dimethoxyethane is used as the ether and 3-pentenenitrile as the diluent, the bottom temperature is, for example, from 110 to 160° C. in the azeotropic distillation under atmospheric pressure. In the same system, it is also possible to carry out the azeotropic distillation under reduced pressure. For example, it is possible to remove 1,2-dimethoxyethane and water at a pressure of 150 mbar and a bottom temperature of 80° C.

In the case of pentenenitrile as the diluent, the distillation may be carried out preferably at a pressure of at most 200 kPa, preferably at most 100 kPa, in particular at most 50 kPa, more preferably at most 20 kPa.

In the case of pentenenitrile as diluent, the distillation may be carried out preferably at a pressure of at least 1 kPa, preferably at least 5 kPa, more preferably at least 10 kPa.

The selection of suitable process conditions allows the formation of different nickel(II)-ether adducts to be controlled. For example, in a system composed of nickel(II) chloride, 1,2-dimethoxyethane and 3-pentenenitrile, a distillation at atmospheric pressure and consequently at elevated temperature provides NiCl₂.0.5 dme, while a distillation under reduced pressure and thus at lower temperatures provides NiCl₂.dme.

The distillation may advantageously be effected by single-stage evaporation, preferably by fractional distillation in one or more, such as 2 or 3, distillation apparatuses. Useful apparatus for the distillation is customary apparatus for this purpose, as described, for example, in Kirk-Othmer, Encyclopedia of Chemical Technology, 3^{rd} ed., Vol. 7, John Wiley & Sons, New York, 1979, page 870-881, such as sieve tray columns, bubble-cap tray columns, columns having structured packing or random packing, columns having sidestreams or dividing wall columns.

The process may be carried out in batch more or continuously.

The process is especially suitable for preparing nickel(II) chloride adducts with 1,2-dimethoxyethane and dioxane.

The present invention is illustrated in detail by the examples which follow.

### EXAMPLES

In the examples of complex synthesis, the chelate ligand solution used was a solution of the chelate phosphonite 1 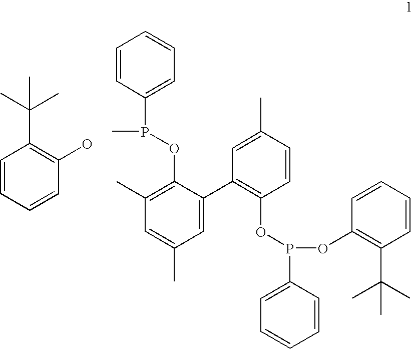
in 3-pentenenitrile (65% by weight of chelate, 35% by weight of 3-pentenenitrile).

To determine the conversion, the complex solutions prepared were investigated for their content of active, complexed Ni(0). To this end, the solutions were admixed with tri(m/p-tolyl) phosphite (typically 1 g of phosphite per 1 g of solution) and kept at 80° C. for approx. 30 min, in order to achieve complete transcomplexation. Subsequently, the current-voltage curve for the electrochemical oxidation was determined in a cyclic voltammetry measurement apparatus in unstirred solution against a reference electrode, which provides the peak current which is proportional to the concentration and determines, via calibration with solutions of known Ni(0) concentrations, the Ni(0) content of the test solutions, corrected by the subsequent dilution with tri(m/p-tolyl) phosphite. The Ni(0) values quoted in the examples report the content of Ni(0) in % by weight based on the entire reaction solution, determined by this method. p In Examples 1 to 9, the reducing agent used was zinc powder:

### Example 1

In a 500 ml flask with stirrer, 18.3 g (83 mmol) of NiCl₂.dme were suspended under argon in 13 g of 3-pentenenitrile and 100 g of chelate solution (86 mmol of ligand) and stirred at 80° C. for 15 min. After cooling to 50° C., 8 g of Zn powder (122 mmol, 1.4 eq.) were added and the mixture was stirred at 50° C. for 3 h. An Ni(0) value of 3.0% (86% conversion) was measured.

### Example 2

A reaction was carried out in a similar manner to Example 1, except that only 7.2 g of Zn (110 mmol, 1.3 eq.) were added. After 3.5 h, an Ni(0) value of 3.3% (94% conversion) was measured.

### Example 3

A reaction was carried out in a similar manner to Example 1, except that only 6 g of Zn (91 mmol, 1.1 eq.) were added. After 12 h, an Ni(0) value of 3.1% (89% conversion) was measured.

### Example 4

A reaction was carried out in a similar manner to Example 1, except that only 17.4 g of NiCl₂.dme (79 mmol) were used, and the temperature was reduced to 30° C. before the Zn powder was added. After 4 h, an Ni(0) value of 3.0% (90% conversion) was measured.

### Example 5

A reaction was carried out in a similar manner to Example 1, except that ligand and nickel salt were prestirred at a temperature of only 60° C. Subsequently, the temperature was reduced to 40° C. before the Zn powder was added. After 4 h, an Ni(0) value of 2.8% (80% conversion) was measured.

### Example 6

In a 500 ml flask with stirrer, 9.1 g (41 mmol) of NiCl₂.dme were suspended under argon in 13 g of 3-pentenenitrile and 100 g of chelate solution (86 mmol of ligand) and stirred at 40° C. for 15 min. 4 g of Zn powder (61 mmol, 1.4 eq.) were added and the mixture was stirred at 40° C. for 4 h. An Ni(0) value of 1.8% (94% conversion) was measured.

### Example 7

In a 4 l flask with stirrer, 367 g (1.67 mol) of NiCl₂.dme were suspended at 50° C. under argon in 260 g of 3-pentenenitrile and 2000 g of chelate solution (1.72 mol of ligand). Subsequently, 120 g of Zn powder (1.84 mol, 1.1 eq.) were added in 30 g portions and the mixture was stirred at 50-55° C. for 4 h. An Ni(0) value of 3.44% (96% conversion) was measured.

### Example 8

In a 250 ml flask with stirrer, 9.2 g (42 mmol) of NiCl₂.dme were suspended under argon in 25 g of adiponitrile and 50 g of chelate solution (43 mmol of ligand) and stirred at 80° C. for 15 min. After coolling to 30° C., 3 g of Zn powder (46 mmol, 1.1 eq.) were added and the mixture was stirred at 50° C. for 5 h. An Ni(0) value of 2.6% (93% conversion) was measured.

### Example 9

A reaction was carried out in a similar manner to Example 8, except that the temperature was reduced to 50° C. before the Zn powder was added. After 5 h, an Ni(0) value of 2.4% (86% conversion) was measured.

In Examples 10-13, the reducing agent used was iron powder.

### Example 10

In a 500 ml flask with stirrer, 18.3 g (83 mmol) of NiCl₂.dme were suspended under argon in 13 g of 3-pentenenitrile and 100 g of chelate solution (86 mmol of ligand) and stirred at 80° C. for 15 min. After cooling to 30° C., 5.3 g of Fe powder (95 mmol, 1.1 eq.) were added and the mixture was stirred at 30° C. for 4 h. An Ni(0) value of 2.8% (79% conversion) was measured.

### Example 11

A reaction was carried out in a similar manner to Example 10, except that the temperature was reduced to 60° C. before the Fe powder was added. After 4 h, an Ni(0) value of 3.0% (84% conversion) was measured.

### Example 12

A reaction was carried out in a similar manner to Example 10, except that the temperature was kept at 80° C. before the Fe powder was added. After 4 h, an Ni(0) value of 2.2% (62% conversion) was measured.

### Example 13

A reaction was carried out in a similar manner to Example 10, except that only 4.5 g of Fe powder (81 mmol, 0.98 eq.) were added. After 4 h, an Ni(0) value of 2.4% (67% conversion) was measured.

In Example 14, the reducing agent used was Et₃Al.

### Example 14

In a 500 ml flask with stirrer, 6.4 g (29 mmol) of NiCl₂.dme were suspended under argon in 67.3 g of chelate solution (58 mmol of ligand) and cooled to 0° C. Subsequently, 20.1 g of a 25% solution of triethylaluminum in toluene (44 mmol) were slowly metered in. After warming the solution to room temperature, it was stirred for another 4 h. An Ni(0) value of 1.8% (99% conversion) was measured.

In Examples 15-17, the nickel source used was nickel bromide-DME adduct.

### Example 15

In a 250 ml flask with stirrer, 8.9 g (29 mmol) of NiBr₂.dme were dissolved under argon in 4.3 g of 3-pentenenitrile and 33 g of chelate solution (29 mmol of ligand) and stirred at 80° C. for 10 min. After cooling to 25° C., 2.4 g of Zn powder (37 mmol, 1.25 eq.) were added and the mixture was stirred at 25° C. for 4 h. An Ni(0) value of 2.8% (81% conversion) was measured.

### Example 16

A reaction was carried out in a similar manner to Example 13, except that the temperature was reduced to 30° C. before the Zn powder was added. After 4 h, an Ni(0) value of 2.4% (69% conversion) was measured.

### Example 17

A reaction was carried out in a similar manner to Example 13, except that the temperature was reduced to 45° C. before the Zn powder was added. After 4 h, an Ni(0) value of 2.5% (72% conversion) was measured.

In Examples 18-20, the ligand solution used was a residual catalyst solution which had already been used as the catalyst solution in hydrocyanation reactions and had been strongly depleted of Ni(0). The composition of the solution is approx. 20% by weight of pentenenitriles, approx. 6% by weight of adiponitrile, approx. 3% by weight of other nitriles, approx. 70% by weight of ligand (consisting of a mixture of 40 mol % of chelate phosphonite 1 and 60 mol % of tri(m/p-tolyl) phosphite) and a nickel(0) content of only 0.8% by weight.

### Example 18

In a 250 ml flask with stirrer, 9.1 g (41 mmol) of NiCl₂.dme were suspended under argon in 24 g of 3-pentenenitrile, admixed with 100 g of residual catalyst solution and stirred at 60° C. for 15 min. Subsequently, 3.4 g of Zn powder (61 mmol, 1.5 eq.) were added and the mixture was stirred at 60° C. for 4 h. An Ni(0) value of 1.25% (corresponding to a P:Ni ratio of 6.5:1) was measured.

### Example 19

A reaction was carried out in a similar manner to Example 18, except that only 2.8 g of Zn powder (43 mmol, 1.1 eq.) were used. After 4 h, an Ni(0) value of 1.2% (corresponding to a P:Ni ratio of 6.7:1) was measured.

### Example 20

A reaction was carried out in a similar manner to Example 18, except that only 3.1 g (15 mmol) of NiCl₂.dme and 1 g of Zn powder (15 mmol, 1.0 eq.) were used. After 4 h, an Ni(0) value of 1.2% (corresponding to a P:Ni ratio of 6.7:1) was measured.

In Examples 21 to 23, the ligand used was tri(m/p-tolyl) phosphite.

### Example 21

In a 250 ml flask with stirrer, 10.0 g (45.5 mmol) of NiCl₂.dme were suspended under argon in 52 g of 3-pentenenitrile, admixed with 64.2 g (182 mmol) of tri(m/p-tolyl) phosphite and stirred at 50° C. for 5 min. Subsequently, 3.3 g of Zn powder (50 mmol, 1.1 eq.) were added and the mixture was stirred at 50° C. for 4 h. An Ni(0) value of 1.6% (75% conversion) was measured.

### Example 22

A reaction was carried out in a similar manner to Example 21, except that 73 g of 3-pentenenitrile and 96.2 g (96 mmol) of tri(m/p-tolyl) phosphite were used. An Ni(0) value of 1.1% (75% conversion) was measured.

### Example 23

In a 250 ml flask with stirrer, 5.0 g (22.8 mmol) of NiCl₂.dme were suspended under argon in 100 g of 3-pentenenitrile, admixed with 144.4 g (410 mmol) of tri(m/p-tolyl) phosphite and stirred at 50° C. for 5 min. Subsequently, 1.7 g of Zn powder (25 mmol, 1.1 eq.) were added and the mixture was stirred at 50° C. for 4 h. An Ni(0) value of 0.5% (98% conversion) was measured.

In Examples 24 and 25, an NiCl₂.DME adduct prepared according to Example 33 was used.

### Example 24

An NiCl₂.dme adduct (83 mmol of Ni) prepared according to Example 33 was resuspended in 13 g of 3-pentenenitrile and admixed with 100 g of chelate solution (86 mmol of ligand). Subsequently, 8 g of Zn powder (122 mmol, 1.5 eq.) were added at 50° C. and the mixture was stirred at approx. 55° C. for 2.5 h. An Ni(0) value of 2.2% (63% conversion) was determined and did not increase even after 4 h at 50-55° C.

### Example 25

An NiCl₂.dme adduct (41 mmol of Ni) prepared according to Example 33 was resuspended in 3 g of 3-pentenenitrile and admixed with 50 g of chelate solution (43 mmol of ligand) and stirred at 80° C. for 10 min. Subsequently, 4 g of Zn powder (61 mmol, 1.5 eq.) were added at 80° C. and the mixture was stirred at approx. 80° C. for 4 h. An Ni(0) value of 2.6% (71% conversion) was determined.

In Example 26, an NiCl₂.0.5 dme adduct prepared according to Example 32 was used.

### Example 26

An NiCl₂.0.5 dme adduct prepared according to Example 32 (83 mmol of Ni) was resuspended in 26 g of 3-pentenenitrile and admixed with 200 g of chelate solution (172 mmol of ligand). Subsequently, 7 g of Zn powder (107 mmol, 1.3 eq.) were added at 40° C. and the mixture was stirred at 40° C. for 1 h. Since no exothermicity or color change were observed, the mixture was heated to 80° C. and stirred for 4 h. An Ni(0) value of 1.2% (63% conversion) was determined.

In Example 27, the suspension of NiCl₂.0.5 dme in 3-pentenenitrile prepared according to Example 34 was used.

### Example 27

The suspension of NiCl₂.0.5 dme adduct prepared according to Example 34 (815 mmol of Ni) in 3-pentenenitrile was admixed with 1000 g of chelate solution (860 mmol of ligand) and stirred at 60-70° C. for a few hours until a homogeneous suspension had formed. Subsequently, the mixture was cooled to 50° C., a total of 65 g of Zn powder (994 mmol, 1.2 eq.) were added in four portions, the mixture was heated to 80° C. and stirred for 4 h. This gave a homogeneous, clear solution. An Ni(0) value of 2.7% (96% conversion) was determined.

In Examples 28-31, the synthesis of the NiCl₂-dioxane adduct and its use in the complex synthesis is described.

### Example 28

In a 250 ml flask with stirrer and reflux condenser, 73 g of NiCl₂.2H₂O (440 mmol) were suspended in 189 g of 1,4-dioxane (2.15 mol, 4.8 eq.) and admixed with 104 g of trimethyl orthoformate (980 mmol, 2.2 eq.). The mixture was heated to 65° C. and refluxed for 3.5 h. Subsequently, the yellow suspension, after cooling, was filtered through a reversible frit and the residue was dried in an argon stream. After subsequent drying in an oil-pump vacuum, 95 g of NiCl₂.dioxane (99%) were obtained as a yellow powder.

Elemental analysis:

| | Theory for NiCl₂•dioxane [%] | Found [%] |
|---|---|---|
| Ni | 26.9 | 26.3 |
| Cl | 32.6 | 32.8 |
| C | 22.1 | 16.6 |
| H | 3.7 | 4.5 |
| O | 14.7 | 19.5 |

Comment on the analysis: cations may distort the oxygen value.

### Example 29

In a 250 ml flask with stirrer, 9.2 g (42 mmol) of NiCl₂.dioxane were suspended under argon in 25 g of 3-pentenenitrile and 50 g of chelate solution (43 mmol of ligand) and stirred at 80° C. for 15 min. Subsequently, 3 g of Zn powder (46 mmol, 1.1 eq.) were added and the mixture was stirred at 80° C. for 4 h. A Ni(0) value of 2.2% (79% conversion) was measured.

### Example 30

A reaction was carried out in a similar manner to Example 29, except that the mixture was cooled to 50° C. before the Zn powder was added. After 4 h, an Ni(0) value of 2.2% (79% conversion) was measured.

### Example 31

A reaction was carried out in a similar manner to Example 29, except that the mixture was cooled to 30° C. before the Zn powder was added. After 3.5 h, an Ni(0) value of 2.0% (71% conversion) was measured.

In Comparative examples 1-4, commercially available, anhydrous nickel chloride was used as the nickel source:

### Comparative Example 1

In a 500 ml flask with stirrer, 11 g (85 mmol) of NiCl₂ were suspended under argon in 13 g of 3-pentenenitrile, admixed with 100 g of chelate solution (86 mmol of ligand) and stirred at 80° C. for 15 min. After cooling to 40° C., 8 g of Zn powder (122 mmol, 1.4 eq.) were added and the mixture was stirred at 40° C. for 4 h. An Ni(0) value of 0.05% (1% conversion) was measured.

### Comparative Example 2

A reaction was carried out in a similar manner to Comparative example 1, except that the temperature was kept at 80° C. when the Zn powder was added. After 5 h, an Ni(0) value of 0.4% (10% conversion) was measured.

### Comparative Example 3

In a 500 ml flask with stirrer, 11 g (85 mmol) of NiCl₂ were suspended under argon in 13 g of 3-pentenenitrile, admixed with 100 g of chelate solution (86 mmol of ligand) and stirred at 80° C. for 15 min. After cooling to 60° C., 5.3 g of Zn powder (95 mmol, 1.1 eq.) were added and the mixture was stirred at 60-65° C. for 10 h. An Ni(0) value of 0.16% (4% conversion) was measured.

### Comparative Example 4

A reaction was carried out in a similar manner to Comparative example 3, except that the temperature was kept at 80° C. when the Fe powder was added. After 10 h, an Ni(0) value of 0.4% (10% conversion) was measured.

Examples 32-35 describe the synthesis of the nickel chloride-DME adduct:

### Example 32

In a 500 ml stirred apparatus with water separator, 19.4 g (82 mmol) of NiCl₂.6H₂O were dissolved in 20 g of water, admixed with 11.1 g (123 mmol, 1.5 eq.) of 1,2-dimethoxyethane and stirred at room temperature overnight. Subsequently, apporox. 150 ml of 3-pentenenitrile were added and the water was separated at atmospheric pressure under reflux (bottom temperature 110-116° C.). After approx. 30 min, 36 ml of water phase (together with distilled-off DME excess) were obtained. The residue, a yellow, pasty solid, was then concentrated to dryness, and a small sample was taken and dried in an oil-pump vacuum.

Elemental analysis:

| | Theory for | | Theory for |
|---|---|---|---|
| | NiCl₂•dme [%] | Found [%] | NiCl₂•0.5dme |
| Ni | 26.7 | 33 | 33.6 |
| Cl | 32.3 | 40.8 | 40.6 |
| C | 21.9 | 11.7 | 13.7 |
| H | 4.6 | 2.4 | 2.9 |
| O | 14.6 | 8.5 | 9.1 |

### Example 33

In a 250 ml stirred apparatus with water separator, 19.7 g (83 mmol) of NiCl₂.6H₂O were dissolved in 20 g of water and admixed with 11.3 g (125 mmol, 1.5 eq.) of 1,2-dimethoxyethane and 100 g of 3-pentenenitrile, and the biphasic mixture was stirred at room temperature for 3 d. The mixture was heated to reflux at approx. 150 mbar (residue max. 80° C.) and the water was separated (30.5 g of water phase). Once no more water was obtained, the mixture was concentrated to dryness. A small sample was taken and dried in an oil-pump vacuum.

Elemental analysis:

| | Theory for NiCl₂•dme [%] | Found [%] |
|---|---|---|
| Ni | 26.7 | 28.5 |
| Cl | 32.3 | 35.9 |
| C | 21.9 | 21.0 |
| H | 4.6 | 3.0 |
| O | 14.6 | 6.8 |

Comment on the analysis: cations may distort the oxygen value.

### Example 34

In a 2 l stirred apparatus with water separator, 135 g (815 mmol) of NiCl₂.2H₂O were suspended in 212 g (2.35 mol, 2.9 eq.) of 1,2-dimethoxyethane and 500 g of 3-pentenenitrile. Subsequently, the water and the DME excess were separated at atmospheric pressure under reflux. A very viscous, partly nonhomogeneous suspension in 3-pentenenitrile was obtained.

### Example 35

In an Erlenmeyer flask, 98.5 g (410 mmol) of NiCl₂.6H₂O were dissolved in 100 g of water, admixed with 56.5 g (630 mmol, 1.5 eq.) of 1,2-dimethoxyethane and stirred at room temperature for a few hours (solution 1).

In a 1 l stirred apparatus with water separator, 350 g of 3-pentenenitrile were heated to reflux at 150 mbar. Subsequently, solution 1 was added dropwise to the refluxing 3-pentenenitrile at just the rate at which the water was removed from the reaction mixture in the water separator. A fine suspension which was stable over several days was obtained.

A small sample (approx. 70 g) of the suspension was taken, filtered off with suction and dried in an oil-pump vacuum.

Elemental analysis:

| | Theory for | | Theory for |
|---|---|---|---|
| | NiCl₂•dme [%] | Found [%] | NiCl₂•0.5dme |
| Ni | 26.7 | 33 | 33.6 |
| Cl | 32.3 | 40.1 | 40.6 |
| C | 21.9 | 6.2 | 13.7 |
| H | 4.6 | 2.9 | 2.9 |
| O | 14.6 | 16.7 | 9.1 |

Comment on the analysis: cations may distort the oxygen value.

Comparative example 5 describes the attempt to synthesize NiCl₂.dme from NiCl₂ and DME.

### Comparative Example 5

In a 250 ml stirred apparatus, 25.9 g of nickel chloride which was free of water of crystallization were suspended under argon in 83 g of 1,2-dimethoxyethane and heated to boiling under reflux for 10 hours. Subsequently, the mixture was filtered off through a reversible frit, dried overnight in an argon stream and subsequently dried further at 30-40° C. in an oil-pump vacuum. 26.5 g of residue were obtained.

Elemental analysis:

| | Theory for NiCl₂•dme [%] | Found [%] |
|---|---|---|
| Ni | 26.7 | 33 |
| Cl | 32.3 | 39.9 |
| C | 21.9 | 11.4 |
| H | 4.6 | 2.9 |
| O | 14.6 | 11.5 |

Example 36 describes the synthesis of the nickel chloride-dioxane adduct:

### Example 36

In an Erlenmeyer flask, 49.3 g (207 mmol) of NiCl₂.6H₂O were dissolved in 50 g of water, admixed with 27.8 g (316 mmol, 1.5 eq.) of 1,4-dioxane and stirred at room temperature for 2 hours (solution 1).

In a 250 ml stirred apparatus with water separator, 350 g of 3-pentenenitrile were heated to reflux at atmospheric pressure. Subsequently, solution 1 was added to the refluxing 3-pentenenitrile at just the rate at which the water was removed from the reaction mixture in the water separator. A fine suspension was obtained.

A small sample was taken from the suspension, filtered off with suction and dried in an oil-pump vacuum.

Elemental analysis:

| | Theory for NiCl₂ dioxane | Found | Theory for |
|---|---|---|---|
| | [%] | [%] | NiCl₂•0.75 dioxane |
| Ni | 27.0 | 28.5 | 30.0 |
| Cl | 32.6 | 34.3 | 36.2 |
| C | 22.1 | 16.4 | 18.4 |
| H | 3.7 | 3.5 | 3.1 |
| O | 14.7 | 12.3 | 12.3 |

1. A process for preparing a nickel(0)-phosphorus ligand complex comprising at least one nickel central atom and at least one phosphorus ligand, which comprises reducing a nickel(II)-ether adduct in the presence of at least one phosphorus ligand selected from the group consisting of phosphites and phosphonites and phosphines and phosphinites with three aromatic substituents.

2. The process according to claim 1, wherein the nickel(II)-ether adduct comprises an ether which is selected from the group consisting of tetrahydrofuran, dioxane, diethyl ether, diisopropyl ether, dibutyl ether, ethylene glycol dialkyl ether, diethylene glycol dialkyl ether and triethylene glycol dialkyl ether.

3. (canceled)

4. The process according to claim 1, wherein the phosphorus ligand is obtained from a ligand solution which was used as a catalyst solution in hydrocyanation reactions.

5. The process according to claim 1, wherein the reducing agent is selected from the group consisting of metals which are more electropositive than nickel, metal alkyls, electrical current, complex hydrides and hydrogen.

6. The process according to claim 1, wherein the reduction is carried out in the presence of a solvent which is selected from the group consisting of organic nitrites, aromatic or aliphatic hydrocarbons and mixtures thereof.

7. The process according to claim 1, wherein reducing the nickel(II)-ether adduct comprises the following process steps:
preparing a solution or suspension of the at least one nickel(II)-ether adduct and of the at least one phosphorus ligand in a solvent under inert gas,
stirring the solution or suspension from step (1) at a temperature of from 20 to 120° C. for a period of from 1 minute to 24 hours for precomplexation,
adding the reducing agent at a temperature of from 20 to 120° C. to the solution or suspension from step (2), and
stirring the solution or suspension from step (3) at a temperature of from 20 to 120° C.

8. A mixture comprising nickel(0)-phosphorus ligand complexes, obtainable by a process according to claim 7.

9. The use of the mixtures comprising nickel(0)-phosphorus ligand complexes according to claim 8 in the hydrocyanation and isomerization of alkenes or in the hydrocyanation and isomerization of unsaturated nitrites.

10. A The process for preparing a nickel(0)-phosphorus ligand complex according to claim 1, wherein the nickel(II)-ether adduct is obtained by dissolving a nickel(II) halide in water, admixing with an ether and a diluent to form a mixture, followed by removing water and any excess ether.

11. The process according to claim 10, wherein the nickel(II) halides are selected from the group consisting of nickel(II) chloride, nickel(II) bromide and nickel(II) iodide.

12. The process according to claim 10, wherein the diluent has a boiling point, in the case that the diluent does not form an azeotrope with water under the pressure conditions of a distillation that is higher than the boiling point of water and is liquid at this boiling point of water, or which forms an azeotrope or heteroazeotrope with water under the pressure and temperature conditions of the distillation, and distilling the mixture comprising the aqueous nickel(II) halide, the ether and the diluent to remove water or the azeotrope or the heteroazeotrope mentioned from the mixture to obtain an anhydrous mixture comprising nickel(II) halide and said diluent.

13. The process according to claim 12, wherein the diluent is an organic nitrile.

14. The process according to claim 10, wherein an ether is used which is selected from the group consisting of tetrahydrofuran, dioxane, diethyl ether, diisopropyl ether, dibutyl ether, ethylene glycol dialkyl ether, diethylene glycol dialkyl ether and triethylene glycol dialkyl ether.

15. The process according to claim 12, wherein an ether is used which is selected from the group consisting of tetrahydrofuran, dioxane, diethyl ether, diisopropyl ether, dibutyl ether, ethylene glycol dialkyl ether, diethylene glycol dialkyl ether and triethylene glycol dialkyl ether.

16. A process for preparing a nickel(0)-phosphorus ligand complex comprising at least one nickel central atom and at least one phosphorus ligand, which comprises reducing a nickel(II)-ether adduct in the presence of a bidentate phosphorus ligand.

17. The process according to claim 16, wherein the nickel(II)-ether adduct comprises an ether which is selected from the group consisting of tetrahydrofuran, dioxane, diethyl ether, diisopropyl ether, dibutyl ether, ethylene glycol dialkyl ether, diethylene glycol dialkyl ether and triethylene glycol dialkyl ether.

18. The process according to claim 16, wherein reducing the nickel(II)-ether adduct comprises the following process steps;
preparing a solution or suspension of the at least one nickel(II)-ether adduct and of the at least one phosphorus ligand in a solvent under inert gas,
stirring the solution or suspension from step (1) at a temperature of from 20 to 120° C. for a period of from 1 minute to 24 hours for precomplexation,
adding the reducing agent at a temperature of from 20 to 120° C. to the solution or suspension from step (2), and
stirring the solution or suspension from step (3) at a temperature of from 20 to 120° C.

19. The use of the nickel(0)-phosphorus ligand complex according to claims 18 in the hydrocyanation and isomerization of alkenes or in the hydrocyanation and isomerization of unsaturated nitrites.
